(19) United States
(12) Patent Application Publication
(10) Pub. No.: US 2026/0241628 A1
(43) Pub. Date: Aug. 20, 2026

(54) An Apparatus for Applying a Coating Material to a Wire

(71) Applicant: Tre Tau Engineering S.R.L., Pianezza (IT)

(72) Inventors: Francesco Taiariol, San Giusto Canavese (IT); Piero Degasperi, Trento (IT); Filippo Veglia, Torino (IT)

(21) Appl. No.: 19/160,580

(22) PCT Filed: Feb. 15, 2024
(86) PCT No.: PCT/IB2024/051413

§ 371 Date: Aug. 28, 2025

(30) Foreign Application Priority Data
Mar. 1, 2023 (IT) 102023000003711

(51) Int. Cl. B29C 48/154; B05C 3/15; B05D 7/20; B29C 48/255; B29C 48/80

(52) U.S. Cl. CPC B29C 48/154; B05C 3/15; B05D 7/20; B29C 48/2552; B29C 48/802

(57) ABSTRACT

An apparatus and a method are provided for applying a coating material to a wire, especially in solvent-free processes. The invention aims to solve prior art problems, such as non-uniform pressure and uneven heating of the coating material, which compromise the uniformity of the applied layer. The innovative solution is a connector made of thermally conductive material and positioned between the injection channel and the coating chamber. This connector includes: (1) a flow regulator with a central portion that shields the wire from the direct impact of the molten material, diverting it through lateral orifices to ensure uniform pressure; and (2) an elongated body that extends into the injection channel to also heat the material from the center, ensuring a homogeneous temperature and optimal viscosity. This design enables a superior and surprisingly uniform coating.

### BACKGROUND OF THE DISCLOSURE

### 1. The Field of the Disclosure

The present invention relates to the field of apparatus for coating a wire with a layer of coating material. More in detail, the invention relates to a coating apparatus of the type capable of applying a layer of coating material on a wire without using any type of solvent (also referred to as “solvent-free coating apparatus” in the rest of the present description).

### 2. The Relevant Technology

An example of a solvent-free coating apparatus for applying a coating material to a wire can be found in the document EP3192081 on behalf of the same assignee.

In particular, a solvent-free coating apparatus according to the state of the art (such as, for example, the apparatus shown in document EP3192081) comprises:
a coating chamber for applying a liquid coating material to a wire passing through the coating chamber, wherein the coating chamber comprises an inlet port through which the wire enters the coating chamber and an outlet port through which the wire exits the coating chamber;
an elongate injection channel configured to be in communication with the coating chamber and comprising an opening for receiving a predetermined quantity of coating material, in particular a solid-state coating material;
at least one heating system configured to progressively raise the temperature of the coating material flowing through the injection channel towards the coating chamber.

As fully described in the aforementioned document EP3192081, one of the key aspects of a solvent-free coating apparatus relies in the ability of correctly injecting the coating material into the coating chamber at a predetermined constant pressure and temperature.

In this respect, the injection channel of the coating apparatus described in EP3192081 comprises an elongated hollow body (e.g., a hollow cylinder) purposedly designed to ease the motion of the coating material from the end of the injection channel towards the inner parts of the coating chamber. To this end, the geometry of the injection channel disclosed in EP3192081 provides a wide opening at the end of it for smoothing the transition of the coating material from the injection channel towards the coating chamber. Due to such geometry, the flow of coating material entering the coating chamber follows a direction longitudinal to the injection channel and perpendicular to the coating chamber, thus hitting the running wire with an angle substantially perpendicular to it. As most of the coating materials employed for coating a wire do not behave ideally (e.g., not behaving according to the Newton's law on viscosity), the hydrodynamic forces generated by the coating material entering the coating chamber may present a chaotic and almost unpredictable distribution across the coating chamber; in particular, the pressure exerted by the coating material on the surface of the wire facing the end of the injection channel (also referred to as “upper pressure”) can be considerably higher than the pressure exerted on the surface of the wire facing the side of the coating chamber opposite to the end of the injection channel (also referred to as “lower pressure”). That is, the hydrodynamic forces generated by the coating material entering perpendicularly into the coating chamber may cause an uneven pressure on the surface of the wire passing through it. The difference between said upper pressure and said lower pressure and, in general, the non-uniform distribution of the pressure exerted on the surface of the running wire may compromise the integrity of the coating layer laid on the wire exiting the coating chamber (e.g., by altering the position of the wire running across the coating chamber).

Moreover, the heating system of the coating apparatus described in document EP3192081 is designed to heat the elongated hollow body enclosing the injection channel by means of at least one heating element directly installed within said elongated hollow body. Thus, the coating material flowing through the injection channel is progressively heated, by thermal conduction, by gradually transferring the heat from the coating material in direct contact with the elongated hollow body towards the coating material flowing in the inner sections of the injection channel. As thermal conduction is a gradual process (i.e., the transfer of heat from the outer sections of the injection channel to the inner sections of it), it may happen that the coating material flowing at a certain speed within the inner sections of the injection channel does not linger long enough in the injection channel to be uniformly heated. As a consequence, the coating material in direct contact with the elongated hollow body of the injection channel may reach higher temperatures than the coating material flowing within the inner sections of the injection channel. Such non-uniform temperature distribution of the coating material entering the coating chamber has a direct negative effect on the viscosity of the coating material and, consequently, on the uniformity of the coating layer of the wire exiting the coating chamber.

### SUMMARY OF THE DISCLOSURE

The goal of the present invention is to overcome few issues which can occur during operation of the solvent-free coating apparatus known in the state of the art, such as, for example, the one described in the patent EP3192081, thus providing a coating apparatus improved under many aspects.

In this frame, the main object of the present invention is to provide an apparatus for applying a coating material to a wire, which is so designed as to overcome the drawbacks of the prior art.

In particular, one object of the present invention is to provide an apparatus for applying a coating material to a wire so designed as to improve the uniformity of the pressure exerted by the coating material injected in the coating chamber on the surface of the wire crossing the coating chamber.

It is another object of the present invention to provide an apparatus for applying a coating material to a wire so designed as to avoid exerting non uniform hydrodynamic forces on the wire thus improving the uniformity of the coating layer of the wire exiting said coating chamber.

It is a further object of the present invention to provide an apparatus for applying a coating material to a wire so designed as to allow a uniform temperature distribution of the coating material flowing within the injection channel, in particular said uniform temperature distribution allowing to obtain an adequate viscosity of the coating material and, consequently, a desired uniformity of the coating layer of the wire exiting the coating chamber.

In view of achieving these objects, the present invention relates to an apparatus for applying a coating material to a wire having all the features indicated in the annexed claim 1. The present invention also relates to a method for applying a coating material to a wire by means of an apparatus according to the present invention.

### BRIEF DESCRIPTION OF THE DRAWINGS

Further objects, features, and advantages of the present invention will become apparent from the following detailed description and from the annexed drawings, which are supplied by way of non-limiting explanatory example, wherein:

FIG. 1 shows a cross-sectioned front view of a preferred embodiment of an apparatus for applying a coating material to a wire according to the present invention;

FIG. 2a shows a front view of a component of the apparatus according to the present invention;

FIG. 2b shows an enlarged perspective view of the component of the apparatus shown in FIG. 2a;

FIG. 2c shows a front bottom view of a first embodiment of the component shown in FIGS. 2a and 2b;

FIG. 2d shows a front bottom view of a second embodiment of the component shown in FIGS. 2a and 2b;

FIG. 3 shows a diagram of a method for applying a coating material to a wire according to the present invention.

### DETAILED DESCRIPTION OF THE PREFERRED EMBODIMENTS

In the following description, various specific details are illustrated aiming at a thorough understanding of examples of one or more embodiments. The embodiments can be implemented without one or more of the specific details, or with other methods, components, materials, etc. In other cases, known structures, materials, or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure.

The references illustrated here are only for convenience and do not therefore delimit the field of protection or the scope of the embodiments.

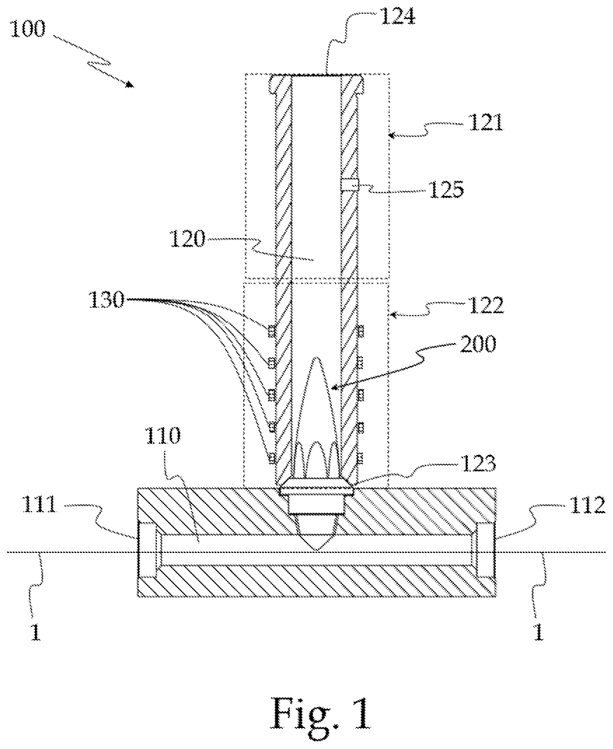

In the annexed FIG. 1, reference 100 generally designates a preferred embodiment of an apparatus for applying a coating material to a wire 1 according to the present invention.

The apparatus 100 may be used to apply a coating material to any type of wire 1, avoiding the use of solvents as primary agent for applying a coating to a wire 1 while guaranteeing optimal mechanical and thermal properties of the resulting coated wire 1. The wire 1 may comprise any type of metal, such as copper, aluminum, or steel. Copper and aluminum wires 1 are typically used for electrical applications, such as for example a winding of an electromagnet. The wire 1 may be characterized by any kind of section geometry (e.g., rounded section, rectangular section, etc.). The coating material can be any type of coating material; for example, the coating material can comprise a plastic coating material such as a thermosetting or a thermoplastic polymer as well as a blend of two or more polymers.

The coating apparatus 100 according to the present invention comprises a coating chamber 110 for applying a coating material to a wire 1 passing through said coating chamber 110; to this end, the coating chamber 110 comprises an inlet port 111 configured for receiving the wire 1 and an outlet port 112 configured for releasing the wire 1. More specifically, the coating chamber 110 has an inlet port 111 through which a wire 1 can pass and enter in the coating chamber 110 and an outlet port 112 through which the wire 1 can come out from the coating chamber 110 with an outer layer of coating material. Preferably, the coating chamber 110 may comprise a cylindrical central section for receiving the coating material; further, the outlet port 112 may comprise a nozzle that tapers conically from a maximum diameter at the junction with the central section to a minimum diameter at the outlet port 112.

The applied coating can comprise any type of coating material such as, for example, thermosetting or thermoplastic polymer material as well as a blend of two or more polymers. Thermosetting materials enable, in general, higher quality coating and perform better at high temperature than thermoplastic materials. The specific type of thermosetting or thermoplastic material that is used may depend on the type of metal of which the wire 1 is made and/or the required properties of the coating according to the final application for which the wire 1 is produced. The thermosetting polymers may comprise, for example, any of polyester, epoxy-polyester mixture, polyethylene, polyurethane, polyethylenimine, polyamide, polyimide, polyamide-imide, a thermosetting polyvinyl formal compound, epoxy, polyesterimide, Polyvinyl fluoride (PVF), and other materials. The coating material may be a mixture or a blend of any of these polymers as well as with other substances, in particular thermosetting additives. For example, a mixture comprising 60% polyvinyl formal and 40% thermosetting additive, or polyesterimide and amideimide mixture, may be used as coating material.

Thermoplastic polymers can comprise, for example, Perfluoroalkoxy (PFA), Polyether ether ketone (PEEK), Polyether ketone ketone (PEKK), Polyetherimide (PEI), Polyphenylene sulfide (PPS), Fluorinated ethylene propylene (FEP), Ethylene tetrafluoroethylene (ETFE), Polytetrafluoroethylene (PTFE), Polyaryletherketone (PAEK), Polyamide-imides (PAI), Polyvinyl fluoride (PVF).

With reference to FIG. 1, the apparatus 100 further comprises an elongate injection channel 120 comprising a bottom end 123 and an upper end 124; said elongated injection channel 120 is configured for receiving a predetermined quantity of solid-state coating material at an opening 125 and for supplying the received coating material to the coating chamber 110 which is arranged in communication with the bottom end 123 of the injection channel 120. More specifically, the injection channel 120 comprises a first portion 121 comprising the opening 125 for receiving solid-state coating material and a second portion 122 configured to be in communication with the coating chamber 110. The injection channel 120 may comprise an elongated hollow body (e.g., a hollow cylinder) made of thermal conductive material (e.g., steel or Inconel).

The coating chamber 110 is configured to be in fluid communication with the bottom end 123 of the injection channel 120, for enabling the passage of the coating material from the injection channel 120 to the coating chamber 110 and for allowing smooth propagation of the pressure from the injection channel 120 to the coating chamber 110.

Prior to being fed into the injection channel 120, the coating material can be in solid-state such as, for example, powder, solid pellets, chips or cartridges or in other solid forms that are generally known for paints and enamels.

According to an aspect of the present invention, the coating material can be inserted into the injection channel 120 by means of an automated feeding system (not shown in FIG. 1) configured for driving the coating material within the injection channel 120 through the opening 125. Preferably, the opening 125 is provided at a side portion of the injection channel 120.

According to known technologies, the automated feeding system may comprise a hopper provided for inserting solid-state coating material, for example in the form of powder, and a duct connecting the hopper with the opening 125. A screw feeding element can be provided within said duct, for rotating within the duct and driving the coating material through the duct, up to reach the opening 125, thus entering into the injection channel 120.

Preferably, the coating apparatus 1 may comprise a support casing comprising a plurality of casings (not shown in FIG. 1) rigidly connected to each other. Said support casing (i.e., each of said casings) can be preferably made of heat conductive material, such as metal, in order to ensure that uniform heating of the coating material (in particular due to the heating system 130 hereinafter described) is maintained within the injection channel 120.

The first portion 121 of the injection channel 120 can be located, for example, within an upper casing, and the second portion 122 can be located, for example, within an intermediate or a lower casing. Furthermore, the injection channel 120 may comprise a hollow cylinder (in particular, a metal cylinder) comprising both the first portion 121 and the second portion 122 of the injection channel 120 that can be inserted, for example, within one or more of said casings of the apparatus 100.

According to an embodiment of the present invention, said injection channel 120 may have a substantially cylindrical shape, in particular with a substantially constant diameter along its entire length, thus avoiding bottleneck-like shape portions which could obstacle flowing of the coating material. This shape of the injection channel 120 enables achievement of an efficient fluid transmission of the coating material towards the coating chamber 110, simple cleaning and maintenance operations of the injection channel 120.

As described in detail in the rest of the present description, in order to achieve a desired viscosity of the coating material in the coating chamber 110, the coating apparatus 100 according to the present invention is configured to progressively heat the coating material as it flows through the injection channel 120. More specifically, the coating apparatus 100 is configured to move the solid-state coating material inserted in the first portion 121 of the injection channel 120 to the second portion 122 of the injection channel 120 where the solid-state coating material is progressively heated until reaching a desired viscosity and density.

To this end, the apparatus 100 according to the present invention further comprises at least one heating system 130 comprising, for example, one or more heating elements; said heating system 130 may be configured to progressively raise the temperature of the coating material as the coating material flows through the injection channel 120, in order to achieve a desired viscosity of the coating material within the coating chamber 110. In particular, said at least one heating system 130 can be configured to transfer a certain quantity of heat to the injection channel 120 and, correspondingly, to the coating material flowing through it according to a predetermined heating progression; for example, the injection channel 120 can comprise a plurality of different heating portions configured to gradually increase the temperature of the injection channel 120 from the upper end 124 (i.e., lower temperatures) to the bottom end 123 (i.e., higher temperatures). Said plurality of different heating portions can be configured so as to follow said predetermined heating progression; for example, a linear heating progression can be achieved by configuring said at least one heating system 130 so as to rise the temperature of each of said plurality of heating zones according to a constant increment from the upper end 124 to the bottom end 123. This way, the coating material flowing through the injection channel 120 is heated according to said predetermined heating progression until reaching a predetermined coating temperature in correspondence of the bottom end 123 of the injection channel 120.

Moreover, the coating apparatus 100 according to the present invention may further comprise a pressurizer (not shown in FIG. 1) configured to press the coating material within the injection channel 120 in order to cause flowing of the coating material through the injection channel 120. Preferably, once a required pressure is reached, the pressurizer does not pressurize the coating material any further, but it can be configured to maintain a constant predetermined pressure of said coating material within the injection channel 120 and the coating chamber 110. Alternatively, in order to exert a predetermined pressure on the coating material, the injection channel 120 may be sealed and connected to a pressurized gas bottle (e.g., a gas bottle filled with pressurized inert gas, e.g., argon) by means of a pressure line.

In accordance with the present invention, the apparatus 100 comprises a connector (designated as a whole with reference number 200 in the annexed drawings) made of thermal conductive material, positioned at the bottom end 123 of the injection channel 120 and configured to connect the injection channel 120 to the coating chamber 110.

As it can be observed also in figures from 2a to 2d, the connector 200 comprises a flow regulator 210 and an elongated body 220, wherein said elongated body 220 comprises at least one first point of contact with said flow regulator 210 and/or with the injection channel 120 and protrudes towards the upper end 124 of said injection channel 120. Said flow regulator 210 and said elongated body 220 are both made of a thermal conductive material, such as metal (e.g., Inconel or steel).

The connector 200 can be manufactured as a single piece body comprising both the flow regulator 210 and the elongated body 220; alternatively, the flow regulator 210 and the elongated body 220 can be manufactured separately and configured to be attached together by means, for example, of a generic fastener.

The flow regulator 210 comprises at least one second point of contact with said injection channel 120. In particular, the flow regulator 210 is preferably configured to fully engage with the bottom end 123 of the injection channel 120; for example, the shape of the flow regulator 210 is configured to match with the shape of the bottom end 123 of the injection channel 120.

As already explained above, as most of the coating materials employed in the wire coating industry do not follow the Newton's law on viscosity, the devices known in the art for controlling the flow of a generic liquid passing through a predetermined point in a pipe are, in general, not suitable to be employed in the above-described coating apparatus 100. Therefore, the flow regulator 210 according to the present invention is specifically designed to account for the non-ideal behavior of the coating material usually employed in the wire coating industry.

The flow regulator 210 according to the present invention is configured to allow the coating material to flow from the injection channel 120 to the coating chamber 110 in a predetermined and controlled manner; more specifically, the flow regulator 210 is characterized by a predetermined flow capacity (i.e., the capability of allowing the coating material to flow from the injection channel 120 to the coating chamber 110). Such predetermined flow capacity of the flow regulator 210 can be defined, for example, as the quantity of coating material flowing through the flow regulator 210 per time unit at a predetermined pressure (e.g., the pressure exerted by said pressurizer). The required value of the flow capacity of the flow regulator 210 can be determined directly or indirectly on the basis of a number of operating parameters of the coating apparatus 100 such as, for example, the type of coating material employed in the coating process, the geometry of the coating layer applied on the wire 1, the quantity of coating material applied on the wire 1 per time unit, the speed at which the wire 1 is pulled across the coating chamber 110, etc.

According to an aspect of the present invention, the flow regulator 210 is configured to shield the wire 1 from the coating material directly entering into the coating chamber 110 in a direction longitudinal with respect to the injection channel 120; more specifically, the flow regulator 210 is configured to limit the pressure directly exerted by the coating material on the surface of the wire 1 facing the bottom end 123 of the injection channel 120 (i.e., the “upper pressure”) so as to be substantially in balance with the pressure exerted on the surface of the wire 1 facing the opposite side of the coating chamber 110 (i.e., the “lower pressure”). As already explained above, as most of the coating materials used for coating a wire 1 do not follow the Newton's law on viscosity, it is important to control the direction and the pressure of the flow of the coating material being injected into the coating chamber 110 so as to guarantee that the pressure exerted on the surface of the wire 1 is as uniformly distributed as possible.

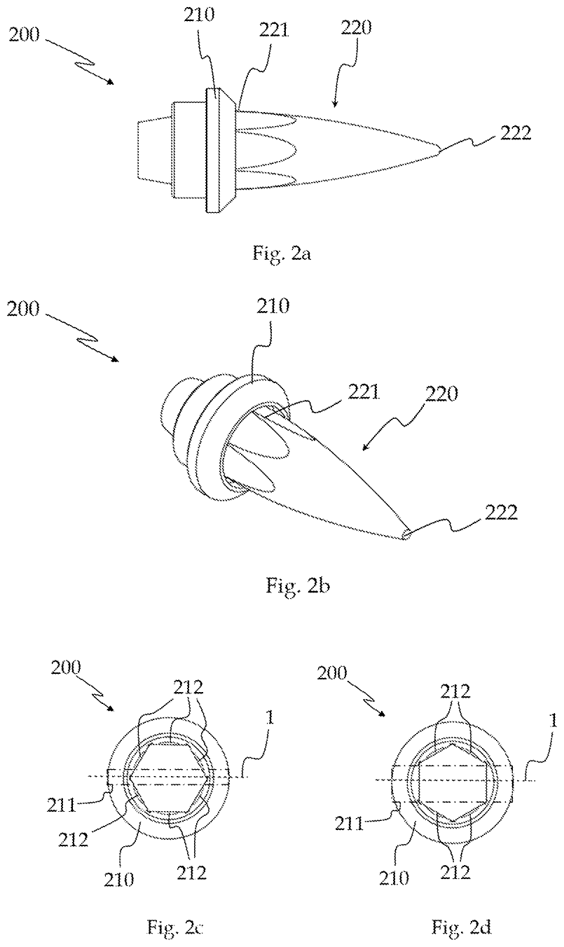

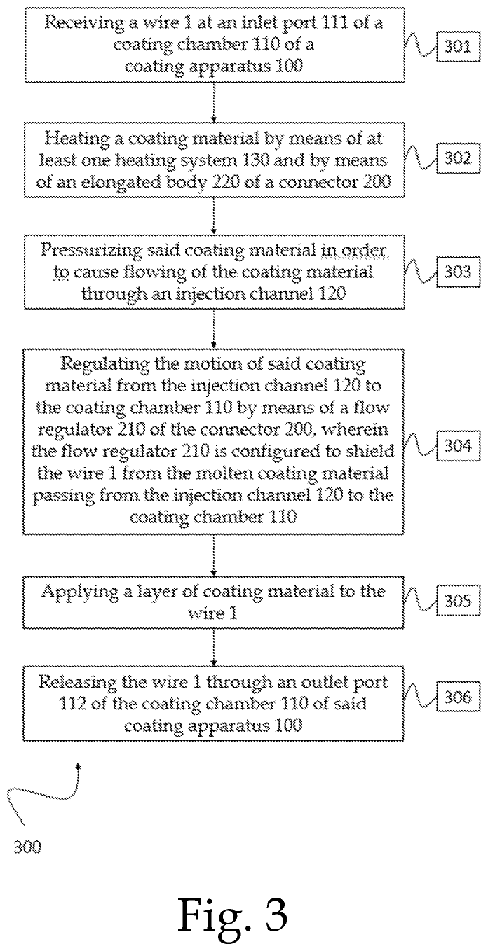

FIGS. 2c and 2d show a front bottom view of two possible different embodiments of the connector 200 according to the present invention and, in particular, two possible different embodiments of the flow regulator 210 of said connector 200.

As shown in FIGS. 2c and 2d, the flow regulator 210 comprises a central portion 211 (which is virtually indicated with an area delimited with dash-dot lines and which can also be called “shielding portion 211”) configured to shield, at least partially (i.e. partially or totally), the wire 1 from the coating material (i.e. the molten polymer) passing from the injection channel 120 to the coating chamber 110, wherein the projection of said central portion 211 intersects the wire 1 in a direction longitudinal to the injection channel 120. More specifically, the central portion 211 is configured to adjust the upper pressure exerted by the coating material on the wire 1 so as to be substantially in balance with the lower pressure.

According to an aspect of the present invention, the flow regulator 210 further comprises at least one first orifice 212 obtained, for example, outside said central portion 211, said at least one first orifice 212 comprising a first flow capacity and being configured to put the injection channel 120 into fluid communication with the coating chamber 110; therefore, said at least one first orifice 212 is also configured to regulate the motion of the molten coating material from the injection channel 120 to the coating chamber 110.

According to a preferred embodiment, the flow regulator 210 may comprise a plurality of first orifices 212, in particular said plurality of first orifices 212 being distributed in a substantially circular fashion and laterally displaced with respect to the central portion 211.

In this respect, said plurality of first orifices 212 are positioned on one or more sectors of a circular crown or annulus comprised in the flow regulator 210, wherein said on one or more sectors are laterally displaced with respect to the central portion 211.

It must be observed that, in the present description, terms like “central” (referred to the central portion 211), “lateral”, “laterally displaced” and similar are referred to a plant view of the flow regulator 210, i.e., a view like the ones shown in FIGS. 2c and 2d.

From the previous description it is clear that said central portion 211 and said at least one first orifice 212 of the flow regulator 210 allow to deviate at least part of the flow of the melted coating material (i.e., the melted coating material coming longitudinally from the injection channel 120 to the coating chamber 110) to one or more areas of the coating chamber 110 not directly crossed by the running wire 1. For example, the flow of coating material can be directed to one or more areas surrounding the running wire 1; in this way, the flow of coating material entering the coating chamber 110 from the injection channel 120 substantially envelopes the portion of the running wire 1 located into said coating chamber 110, with the result of exerting a uniform pressure on its surface.

Furthermore, the flow regulator 210 can comprise a second orifice (not shown in the drawings) obtained and located within said central portion 211 and comprising a second flow capacity; said second orifice can be configured to adjust the pressure of the coating material engaging directly with the upper surface of the wire 1 (i.e., the coating material entering the injection channel 120 through said central portion 211). Therefore, the second orifice can be configured to balance the pressure exerted on the surface of the wire 1 (i.e., to balance the upper pressure with the lower pressure). For example, said second flow capacity can be configured to be substantially lower than said first flow capacity; that is, the quantity of coating material allowed to flow, per time unit, through the second orifice can be substantially lower than the quantity of coating material allowed to flow, per time unit, through the first orifice 212. As a result, the quantity of coating material entering the coating chamber 110 directly through the central portion 211 can be configured to be substantially lower than the quantity of coating material entering through the portions of the flow regulator 210 located outside the central portion 211. As a consequence, by advantageously designing the first orifice 212 and the second orifice (i.e., the first flow capacity and the second flow capacity), it is therefore possible to balance the pressure exerted by the coating material on the surface of the wire 1. The optimal values of the first flow capacity and the second flow capacity can be determined experimentally by means, for example, of a multi-step design approach. Specifically, the values of the first flow capacity and the second flow capacity can be determined through mathematical optimization by minimizing the difference of the lower pressure and upper pressure while constraining the solution to a predetermined value of the flow capacity of the flow regulator 210; on this basis, a mathematical relation (e.g., a linear relationship) between the first flow capacity and the second flow capacity can be determined so as to guarantee said predetermined flow capacity of the flow regulator 210. Optimal values of the first flow capacity and the second flow capacity satisfying the above-mentioned mathematical relationship can be then determined experimentally or by means of one or more computer simulations (e.g., by means of a fluid dynamic simulator such as, for example, Comsol Multiphysics). For example, in order to search for optimal values of the first flow capacity and the second flow capacity, a brute force algorithm can be employed with the objective of minimizing the difference between the upper pressure and the lower pressure. More in general, the peculiar design of the flow regulator 210 according to the present invention allows to shield the wire 1 from the coating material directly entering the coating chamber 110 from the injection channel 120, thus preventing the melted coating material (i.e., the polymer entering into the coating chamber 110) from exerting a non-uniform pressure on the surface of the wire 1 running through the coating chamber 110.

Further, since the flow regulator 210 is made of conductive material and is configured to comprise at least one second point of contact with the surface of the injection channel 120 and since also the elongated body 220 is made of conductive material and is configured to comprise at least one first point of contact with the surface of the flow regulator 210 and/or with the surface of said injection channel 120, the heat generated by the at least one heating system 130 is gradually transferred by thermal conduction to the connector 200, in particular, to both the flow regulator 210 and the elongated body 220 of said connector 200. The technical effect brought about by such feature is multifold.

First, thanks to said at least one second point of contact with the surface of the injection channel 120, the flow regulator 210 is heated until reaching approximately the same temperature of the injection channel 120 in correspondence to said at least one second point of contact. Therefore, the melted coating material passing through said at least one first orifice 212 and, possibly, through said second orifice, is kept at said predetermined coating temperature.

Secondly, thanks to said at least one first point of contact with the surface of the flow regulator 210 and/or with the surface of the injection channel 120, at least part of the elongated body 220 is heated by thermal conduction.

According to a preferred embodiment of the present invention, the elongated body 220 may comprise at least two portions (also called heating portions), each of which characterized by different operating temperatures (i.e., the temperature characterizing each of said heating portions of the elongated body 220 when the coating apparatus 100 is in full operation). For example, each heating portion of the elongated body 220 can be characterized by a different mass, a different material, a different superficial area, a different thermal inertia and so on. The quantity of heat transferred from the elongated body 220 to the coating material flowing in the inner sections of the injection channel 120 may therefore vary according to each of said heating portions of the elongated body 220.

Therefore, the coating material flowing in the inner sections of the injection channel 120 may be heated according to a predetermined heating progression; preferably, the coating material flowing in the inner sections of the injection channel 120 may follow the same predetermined heating progression of the coating material flowing in the outer sections of the injection channel 120. To this end, the heating progression of the elongated body 220 can follow the same heating progression of the injection channel 120.

Preferably, the elongated body 220 has a substantially conical-type shape and comprises a base 221 connected to the flow regulator 210 and an apex 222 pointing towards the upper end 124 of the injection channel 120. Said substantially conical-type shape brings about the effect of increasing the thermal inertia of the elongated body 220, for example continuously, from the apex 222 to the base 221 with the effect of increasing the operating temperatures of elongated body 220 from the apex 222 to the base 221; in general, the elongated body 220 may be designed such that its base 221 is characterized by having more thermal inertia than its apex 222, so that the operating temperature of the base 221 exceeds the operating temperature of the apex 222.

In this respect it must be observed that the contact surface area between a conical-type shaped elongated body 220 and the coating material gradually increases as the coating material progresses from the apex 222 to the base 221 of the elongated body 220. As a result, the conical-type shape of the elongated body 220 naturally allows more heat exchange at the base 221 of the elongated body 220 than at its apex 222. This feature allows to better follow the predetermined heating progression established by the at least one heating system 130 on the surface of the injection channel 120 (e.g., the surface of the hollow body enclosing the injection channel 120), wherein more heat exchange is carried out at the bottom end 123 of the injection channel 120 than at other portions of said injection channel 120.

The thermal inertia and, correspondingly, the operating temperatures of each of said heating portions of the elongated body 220 can be determined as a function of the heating progression followed by the surface of the injection channel 120 (e.g., the surface of the hollow body enclosing the injection channel 120). To this end, the conical-type shape of the elongated body 220 can be experimentally designed as a function of the heating progression followed by the surface of the injection channel 120. For example, given a predetermined heating progression of the surface of the injection channel 120, a heuristic design approach can be employed to search for an optimal or sub-optimal conical-type shape of the elongated body 220. Specifically, starting from a plurality of feasible conical-type shape designs, a fluid dynamic simulator (e.g., Comsol Multiphysics) can be employed to experimentally search for the optimal conical-type shape design among said plurality of feasible conical-type shape designs that better approximates said predetermined heating progression of the surface of the injection channel 120.

In general, the elongated body 220 allows to heat the coating material flowing in the inner sections of the injection channel 120, with the result of optimizing the uniformity of the heating of the coating material inside the injection channel 120.

In the following of the present description there will be described in detail a method 300 for applying a coating material to a wire 1 by means of the apparatus 100 according to the present invention.

The method 300 according to the present invention comprises a step 301 wherein the wire 1 is received at the inlet port 111 of the coating chamber 110 of said coating apparatus 100.

As explained above, the coating apparatus 100 is configured for receiving a predetermined quantity of solid-state coating material at the opening 125 and for operating said at least one heating system 130 in order to heat and melt the coating material until reaching a predetermined coating temperature and density. According to an aspect of the present invention, the method 300 for applying a coating material to a wire 1 allows to optimize the process of heating the coating material flowing through the injection channel 120.

To this end, the method 300 comprises a step 302 of heating the coating material flowing through the injection channel 120 by means of said at least one heating system 130 and by means of said elongated body 220. In particular, said at least one heating system 130 is operated to heat the injection channel 120 and, consequently, the elongated body 220 by thermal conduction. As a result, the coating material flowing though the injection channel 120 is heated uniformly; besides, as already explained above, the elongated body 220 can be configured to follow the same heating progression of the injection channel 120.

At step 303 the coating material contained within the injection channel 120 is pressurized (for example, by means of said pressurizer 105 or by means of a pressurized gas) in order to cause flowing of the coating material through the injection channel 120.

The method 300 according to the present invention allows to properly regulate the transfer of the melted coating material from the bottom end 123 of the injection channel 120 to the coating chamber 110, for example in order to avoid exerting an unbalanced pressure on the surface of the wire 1.

To this end, the method 300 comprises a step 304 of regulating the motion of the coating material from the injection channel 120 to the coating chamber 110 by means of the flow regulator 210. Specifically, the flow regulator 210 is configured to shield, at least partially, the wire 1 from the molten coating material (in particular, a molten polymer) being transferred from the injection channel 120 to the coating chamber 110.

At step 305, a layer of coating material is therefore applied to the wire 1 and at step 306 the wire 1 is released through the outlet port 112 of the coating chamber 110.

The wire 1 obtainable by the method 300 according to the present invention is characterized by unique properties which are not achievable by known coating techniques; in particular, the wire 1 obtained by the method 300 is characterized by a surprisingly uniform coating layer along its entire length. The combined use of the elongated body 220 capable of uniformly heating the coating material and the flow regulator 210 capable of balancing the pressure exerted by the coating material on the wire 1 brings about the technical effect of allowing to apply a uniform coating layer on the entire length of the wire 1.

The features of the apparatus 100 for applying a coating material to a wire 1 according to the present invention, as well as the advantages thereof, are apparent from the above description. In fact, the provisions of the present invention allow to provide an apparatus 100 for applying a coating material to a wire 1, wherein said apparatus 100 is so designed as to overcome the drawbacks of the prior art.

In this respect, it must be observed that the provisions and the features of the connector 200 according to the present invention allow to optimize the uniformity of the pressure exerted on the surface of the wire 1 by the coating material within the coating chamber 110, thus optimizing the uniformity of the coating layer of the wire 1 exiting said coating chamber 110.

The connector 200 according to the present invention also allows to obtain a uniform temperature distribution of the coating material flowing within the injection channel 120, in particular said uniform temperature distribution allowing to obtain an adequate viscosity of the coating material and, consequently, a desired uniformity of the coating layer of the wire 1 exiting the coating chamber 110.

The apparatus 100 described herein by way of example may be subject to many possible variations without departing from the novelty spirit of the inventive idea; it is also clear that, in the practical implementation of the invention, the illustrated details may have different shapes or be replaced with other technically equivalent elements.

1. An apparatus for applying a coating material to a wire, said apparatus comprising:
a coating chamber for applying a coating material to a wire passing through the coating chamber, wherein the coating chamber comprises an inlet port configured for receiving the wire and an outlet port configured for releasing the wire;
an elongate injection channel comprising a first portion and a second portion, said first portion comprising an opening for receiving a predetermined quantity of coating material, said second portion being configured to be in communication with the coating chamber;
at least one heating system configured to raise, in particular progressively, the temperature of the coating material as the coating material flows through the injection channel,
said apparatus further comprising a connector made of a thermal conductive material, positioned at a bottom end of the injection channel and configured to connect the injection channel to the coating chamber, said connector comprising a flow regulator and an elongated body,
wherein said elongated body comprises at least one first point of contact with said flow regulator and/or with the injection channel and protrudes towards an upper end of said injection channel, and wherein the flow regulator comprises:
at least one second point of contact with said injection channel,
a central portion configured to shield, at least partially, the wire from the coating material passing from the injection channel to the coating chamber, wherein the projection of said central portion intersects the wire in a direction longitudinal to the injection channel;
at least one first orifice obtained outside said central portion, said at least one first orifice being configured to put the injection channel into fluid communication with the coating chamber and to regulate the motion of the coating material from the injection channel to the coating chamber.

2. The apparatus according to claim 1, wherein the flow regulator comprises a second orifice obtained within said central portion, said first orifice comprising a first flow capacity, said second orifice comprising a second flow capacity, said second flow capacity being lower than said first flow capacity.

3. The apparatus according to claim 1, wherein the shape of the flow regulator is configured to match with the shape of the bottom end of the injection channel.

4. The apparatus according to claim 1, wherein the flow regulator comprises a plurality of first orifices, in particular said plurality of first orifices being distributed in a substantially circular fashion and laterally displaced with respect to the central portion.

5. The apparatus according to claim 1, wherein the elongated body comprises at least two portions having different operating temperatures.

6. An The apparatus according to claim 5, wherein the elongated body has a substantially conical-type shape and comprises a base connected to the flow regulator by said at least one first point of contact and an apex pointing towards the upper end of the injection channel.

7. The apparatus according to claim 6, wherein the base has more thermal inertia than said apex of said elongated body.

8. A connector made of a thermal conductive material for connecting an injection channel to a coating chamber of an apparatus for applying a coating material to a wire according to claim 1, said connector being positioned at a bottom end of the injection channel, said connector comprising a flow regulator and an elongated body,
wherein said elongated body comprises at least one first point of contact with said flow regulator and/or with the injection channel and protrudes towards an upper end of said injection channel,
and wherein the flow regulator comprises:
at least one second point of contact with said injection channel
a central portion configured to shield the wire from the coating material passing from the injection channel to the coating chamber, wherein the projection of said central portion intersects the wire in a direction longitudinal to the injection channel;
at least one first orifice obtained outside from said central portion, said at least one orifice being configured to put the injection channel into fluid communication with the coating chamber and to regulate the motion of the coating material from the injection channel to the coating chamber.

9. A method for applying a coating material to a wire by an apparatus according to claim 1, comprising:
receiving the wire at an inlet port of a coating chamber of said coating apparatus;
heating the coating material by said at least one heating system and by of said elongated body;
pressurizing said coating material in order to cause flowing of the coating material through the injection channel;
regulating the motion of said coating material from the injection channel to the coating chamber by the flow regulator, wherein the flow regulator is configured to shield, at least partially, the wire from the molten coating material passing from the injection channel to the coating chamber;
applying a layer of coating material to the wire;
releasing the wire through an outlet port of the coating chamber of said coating apparatus.

10. (canceled)
